(19) United States
(12) Patent Application Publication
(10) Pub. No.: US 2022/0262193 A1
(43) Pub. Date: Aug. 18, 2022

(54) SYSTEM AND METHODS FOR MANAGING A DYNAMIC BETTING LINE

(71) Applicant: Andrew Brent Sellers, South Jordan, UT (US)

(72) Inventor: Andrew Brent Sellers, South Jordan, UT (US)

(21) Appl. No.: 17/177,447

(22) Filed: Feb. 17, 2021

(51) Int. Cl. G07F 17/32

(52) U.S. Cl. CPC G07F 17/326; G07F 17/3288

(57) ABSTRACT

In one example in accordance with the present disclosure a dynamic odds-making computing device includes computer processors and computer-readable storage media comprising instructions stored thereon. Responsive to execution of the instructions, the dynamic odds-making computing device, opens a betting window during which the dynamic odds-making computing device is to receive bets on outcomes of an event and 2) receives, from one or more input devices, multiple bets on the outcomes of the event. The dynamic odds-making computing device also dynamically adjusts a betting line based on received multiple bets and provides a current value of a dynamically adjusted betting line to output devices. The dynamic odds-making computing device also closes the betting window after which bets are not received by the odds-making computing device and applies, to the received multiple bets, the dynamically adjusted betting line at the closing of the betting window as a final betting line.

### BACKGROUND

In conventional betting, a bookmaker or other party to facilitates betting on an event. For example, for betting on a football game, a bookmaker sets a betting line (or betting odds) for an outcome of the football game. The betting line indicates an amount of payout for a bet on a specific outcome. As a more specific example, a betting line of −110 on team 1 means that a bettor with a bet of $110 on a win by team 1 would win $100 if team 1 wins the football game.

### SUMMARY

This disclosure describes betting methods and devices that facilitate event betting with dynamic betting lines for past, current, and future bets. The dynamic betting lines can be based, for example, on a current amount of funds for bets on each outcome available for betting. More specifically, in an example, if 60% of betting is on outcome 1 and 40% of betting is on outcome 2, the payout for a bet on outcome 1 would be ⅔ of a bet amount. The bookmaker can charge a fee from the payout. As described in the present specification, a bettor may be permitted to change betting outcomes, but not bet amounts, until a specified time or event as the dynamic betting line changes, which change itself will impact the dynamic betting line. The methods and devices described herein would remove the risk of the bookmaker of losing money by an incorrectly set betting line by ensuring that a payout for winning bets, before subtracting any bookmaker fees, will equal an amount of funds received from losing bets. Further, the methods and devices described herein remove a risk of losing money for an improper betting line or taking too long to adjust a betting line because the betting line is adjusted dynamically and because the final betting line is applied to and determined by the received bets, rather than a fixed betting line at the time a bet is received.

In an example, a dynamic odds-making computing device includes one or more computer processors and one or more computer-readable storage media. The computer-readable storage media includes instructions stored thereon that, responsive to execution by the one or more computer processors, causes the computer processors to perform operations. The operations include opening a betting window during which the dynamic odds-making computing device is configured to receive bets on one or more outcomes of an event. Another operation includes receiving, from one or more input devices, multiple bets on the one or more outcomes of the event. A further operation includes dynamically adjusting an initial betting line based on received multiple bets. Yet another operation includes providing, to one or more output devices, a current value of the dynamically adjusted betting line. Still further, another operation includes closing the betting window after which bets are not received by the odds-making computing device. After closing the betting window, another operation includes applying, to the received multiple bets, the dynamically adjusted betting line at the closing of the betting window as a final betting line.

The present specification also describes a method. According to the method, a betting window is opened during which the dynamic odds-making computing device is to receive bets on one or more outcomes of the event. The odds-making computing device receives, from one or more input devices, multiple bets on the one or more outcomes of the event. An initial betting line is dynamically adjusted based on received multiple bets. A current value of the dynamically adjusted betting line is provided to one or more output devices. The dynamic odds-making computing device closes the betting window after which bets are not received by the odds-making computing device. After closing the betting window, the dynamic odds-making computing device applies, to the received multiple bets, the dynamically adjusted betting line at the closing of the betting window as a final betting line.

The present specification also describes a method. According to another example, an event is defined for which an odds-making computing device is to receive bets on one or more outcomes of the event. One or more outcomes for the event are defined and the odds-making computing device opens a betting window during which the odds-making computing device is to receive bets on one or more outcomes of the event. The odds-making computing device receives, from one or more input devices, multiple bets on the one or more outcomes of the event and sets an initial betting line for the one or more outcomes of the event. The odds-making computing device closes the betting window after which bets are not received by the odds-making computing device. After closing the betting window, the odds-making computing device applies, to the received multiple bets, the betting line at the closing of the betting window.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an environment and odds-making computing device for managing a dynamic betting line according to an example of the principles described herein.

FIG. 2 illustrates a method for managing a dynamic betting line, according to an example of the principles described herein.

FIG. 3 illustrates a method for managing a betting line, according to an example of the principles described herein.

FIG. 4 depicts a non-transitory computer-readable storage medium for managing a dynamic betting line, according to an example of the principles described herein.

### DETAILED DESCRIPTION

### Example Environment

In conventional betting, a bookmaker or other party to facilitates betting on an event. When a bettor chooses an outcome on which to place a bet, he bets on a current betting line. As betting continues, the bookmaker may move the betting line based on past bets, injuries, weather forecasts, or other facts. However, betting lines for past bets are static, even if the betting line moves. In general, the goal of the bookmaker is to set the betting line so that an amount of payout for winning bets, after taking out the bookmaker's fee, is equal to an amount of money taken in from losing bets. If a bookmaker improperly sets a betting line, or takes too much time to move the betting line, the bookmaker risks losing money.

For the service of facilitating the betting, the bookmaker charges a fee against winnings from successful bets. Generally, the fee is sufficiently high to make a profit and offset a risk of a total payout to winners being greater than a total amount of money taken in from losing bets. However, existing betting systems may be costly to bettors due to the high bookmaker fee and existing systems may not be able to provide consistent betting odds for those bettors that place bets throughout an entire betting window, for example to bet based on a moving betting line.

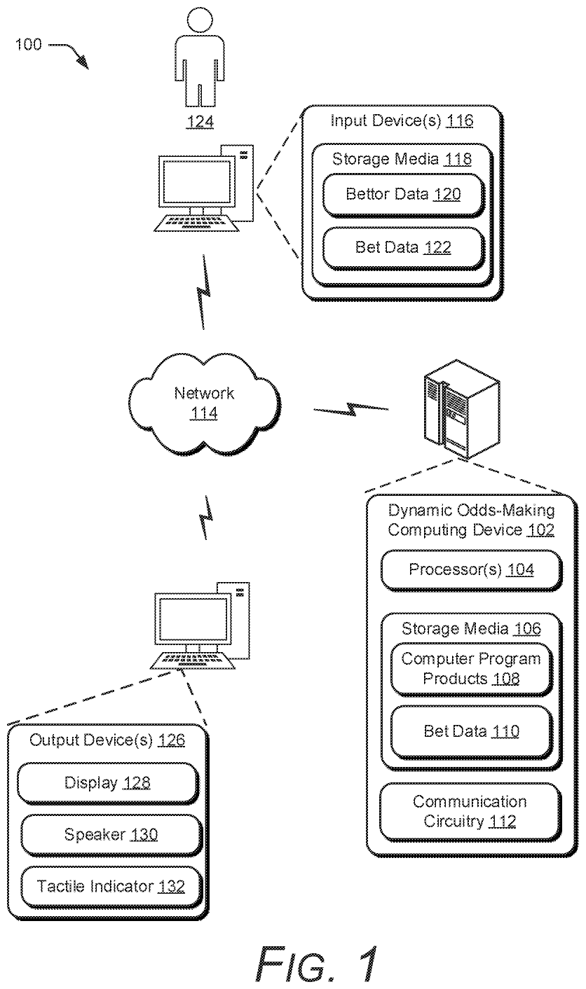

Turning now to the figures, FIG. 1 illustrates an environment 100 and odds-making computing device 102 that manages a dynamic betting line. Environment 100 includes a dynamic odds-making computing device 102 having processing circuitry which may include one or more processor(s) 104 and storage media 106 storing one or more computer program products 108 and bet data 110. The computer program products 108 may include instructions that, responsive to execution by the processor(s) 104, cause the dynamic odds-making computing device 102 to perform operations. The operations may include setting an initial betting line by, for example, choosing even odds. In another example, the initial betting line may be set after a minimum quantity of bets or a minimum amount of money is placed on one or more of the outcomes. The initial betting line may be set such that a payout for a bet on a particular outcome is based on a ratio of total bets on all other outcomes to total bets on the particular outcome. A bookmaker fee may be taken from the payout for winning bets.

In an example, the dynamic odds-making computing device 102 receives bets via communication circuitry 112. In an example, of the received bets, ⅓ of the money is placed on outcome 1 and ⅔ is bet on outcome 2. In this example, when outcome 1 occurs, a bet on outcome 1 is paid with odds (a payout multiple) of 2:1.

The dynamic odds-making computing device 102 may receive the bets via a network 114, for example, the internet. The network 114 provides a connection between the dynamic odds-making computer device 102 and one or more input device(s) 116. The input device(s) 116 includes storage media 118 that includes bettor data 120 and bet data 122. The bettor data 120 includes information for identifying a user 124 placing a bet. For example, bettor data 120 may include one or more of bank account information for the user, payment card information for the user, a name of the user 124, and a phone number of the user 124. While particular reference is made to particular bettor data 120, a variety of other identifying information for a user may be included in the storage media 118 as bettor data 120.

The bet data 122 may include one or more of an amount of money committed to the bet, an outcome on which the bet is initially placed, and a condition for changing the outcome on which the bet is placed. The bettor data 120 and the bet data 122 may be collectively referred to as a bet. Multiple bets may be received via one or many input devices 116.

The dynamic odds-making computing device 102 is also connected to output device(s) 126 via the network 114. The output device(s) 126 may include one or more of a display 128, a speaker 130, or a tactile indicator 132. The output device(s) 126 may receive a current value of a dynamically adjusted betting line, or an indication regarding the same, as provided by the dynamic odds-making computing device 102 via the network 114. The output device(s) 126 provide the current value of a dynamically adjusted betting line, or an indication regarding the same, to a user. In some examples, in input device 116 and an output device 126 may be co-located or may be a same computing device such as a betting terminal, a mobile phone, or a personal computer. For example, the odds-making computing device 102 may receive the bet from a mobile device. The odds-making computing device 102 may also send the current value of the dynamically adjusted betting line to the same mobile device.

### Example Methods

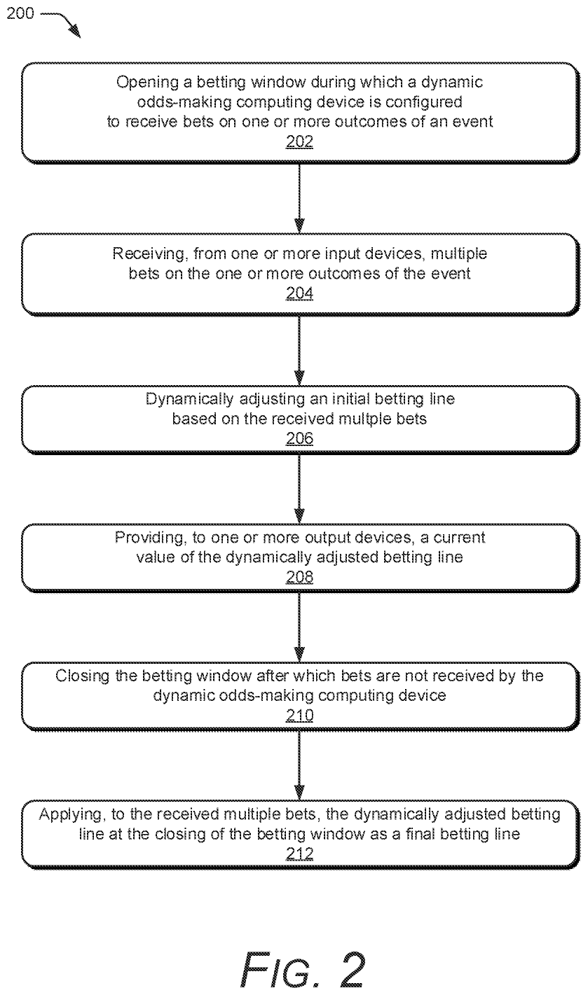

FIG. 2 illustrates a method 200 for managing a dynamic betting line. The method 200 may be performed by the odds-making computing device 102 for betting on an event. The operations may be performed by the processor(s) 104 executing instructions stored on the storage media 106, which instructions may be included in one or more computer program products 108. Some of the operations may be performed via the communication circuitry 112.

At operation 202, the odds-making computing device 102 opens a betting window during which the odds-making computing device 102 is configured to receive bets on one or more outcomes of an event. In some examples, the odds-making computing device 102 may provide a bet commitment window. During the bet commitment window, the odds-making computing device 102 receives a commitment of funds for betting on the event. The bet commitment window may be before, during, or after the betting window. The odds-making computing device 102 may then close the bet commitment window, wherein the committed funds are non-refundable and are dedicated for use on a bet on the event.

At operation 204, the odds-making computing device 102 receives, from one or more input devices 116, multiple bets on the one or more outcomes of the event. In some examples, the odds-making computing device 102 receives, during the betting window, a modification to one or more of the multiple bets. For example, the modification may include changing the bets to an outcome that is different from an initially chosen outcome for the bets.

At operation 206, the odds-making computing device 102 dynamically adjusts an initial betting line based on the received multiple bets.

At operation 208, the odds-making computing device 102 provides, to one or more output devices 126, a current value of the dynamically adjusted betting line. In some examples, the odds-making computing device 102 also provides, to the one or more output devices 126, sponsored media during or after the betting window. The odds-making computing device 102, or an owner of the same, may receive compensation for providing the sponsored media from a sponsor of the sponsored media. In an example, the odds-making computing device 102 may receive seed money for the event to improve a betting line for bettors on the event.

One or more of the input devices 116 and output devices 126 may be remote from the odds-making computing device 102. In some of these examples, the remote devices are connected to the odds-making computing device 102 via a network, such as the network 114. In particular examples, one or more of the input devices 116 or output devices 126 are located in multiple different cities.

At operation 210, the odds-making computing device 102 closes the betting window after which bets are no longer received by the odds-making computing device 102.

At operation 212, the odds-making computing device 102 applies, to the received multiple bets, the dynamically adjusted betting line at the closing of the betting window as a final betting line.

In some examples, a betting platform does not require a “line” or set “odds” for those that desire to bet on an event/outcome. The odds-making computing device 102 of the present specification may facilitate betting in this scenario as well. Specifically, the odds-making computing device 102 provides on-demand, real-time odds updates to bettors. Specifically, the odds-making computing device 102 may implement phased betting. By establishing set phases, the bettors will establish the odds, with the odds-making computing device 102 tracking and updating odds in real-time. Doing so may remove the need and cost of bookkeepers and may reduce the number of bettors required to implement a betting event. Additionally, breaking the betting into phases allows for the platform to ensure that it is not an inadvertent participant.

In an example of phased betting, the first phase requires that a bettor decide 1) whether or not to bet on an event and 2) how much to bet on the event. The odds are not set during this first phase. Once a bettor decides to participate, then the bettor may not be able to cancel or remove committed funds. In some cases, there may be a period of time where bettors are soft-committed. During a soft commitment, the bettors may be able to pull money from the pool prior to a certain defined event. Such a soft commitment period may be prior to a locked pool phase. The odds-making computing device 102 can track the locked pool and update participants as to how much money is committed.

During the first phase, a bettor may initially choose which outcome to bet on, however in some examples this decision is not locked until the end of a later phase. The odds-making computing device 102 can track the dollars committed to each outcome and update odds in real-time.

In some examples, the betting pool may be seeded with initial funds. For example, a betting pool may be sponsored or seeded with funds, such that the payouts exceed the amount input. These seed funds may be provided from advertisers or sponsors.

In phased betting, the odds-making computing device 102 may also include a second phase wherein the odds-making computing device 102 provides the betting line based on received bets. In an example, the payout, and therefore the odds, for each outcome may be locked based on a specified time or other condition (“odds lock event”). During the second phase and until the odds lock event, bettors can change their bet to any outcome. The odds can be updated and provided via an output device in real time based on bettors' selections, the bettors' committed bet amount, and the size of the pool. In this way, the odds-making computing device 102 allows for changed circumstances to be incorporated to the entire pool for all bettors.

For example, assume there are 10 bettors, each betting $1. If 5 bettors choose outcome A and 5 bettors choose outcome B, then the odds will be 2:1 for bets on both A and B (i.e., if B occurs, then B bettors would be paid out $2 each for every $1 bet). Continuing this example, if 1 bettor chooses outcome A and 9 bettors choose outcome B, then the odds would be 10:1 and 10:9 respectively for A and B (i.e., if A occurs, then A bettor would be paid $10).

As described, the odds-making computing device 102 can update the betting line in real-time and provide each bettor his or her odds based on a modification to their bet (i.e., one or both of the odds for a selected outcome and the odds if the bettor switches choice). Because the betting line is dynamic, bettors will be incentivized to track real-time updates up to the odds lock event. For example, if a team is resting a player or a player is questionable for a game, a bettor can modify a bet when confirmation of the update (i.e., the player is rested or will not be playing in the game) is obtained. This can provide an opportunity to increase web page views, or application executions on an output device 126, which can provide an opportunity for increased revenue through advertising on the web page or application. This increased revenue opportunity can allow an operator of the odds-making computing device 102 to charge users a relatively low service fee compared to a bookkeeper.

In an example, the odds-making computing device 102 may also include a third phase when the event concludes. The betting line will be locked prior to the conclusion of the event. In some implementation, the betting line will be locked prior to the beginning of the event. The event may have a unique odds lock event that is described to the bettor prior to locking. For example, an odds lock event for a baseball game may be immediately following the first pitch. Once the event concludes the locked pool will be paid out to the bettors that bet on the correct outcome. In some examples, there may be more than one outcome option so long as the options include all possible outcomes. For example, outcome options for a baseball game may include be choosing one of the teams to win and outcome options for a soccer game would be choosing one of the teams to win or a tie.

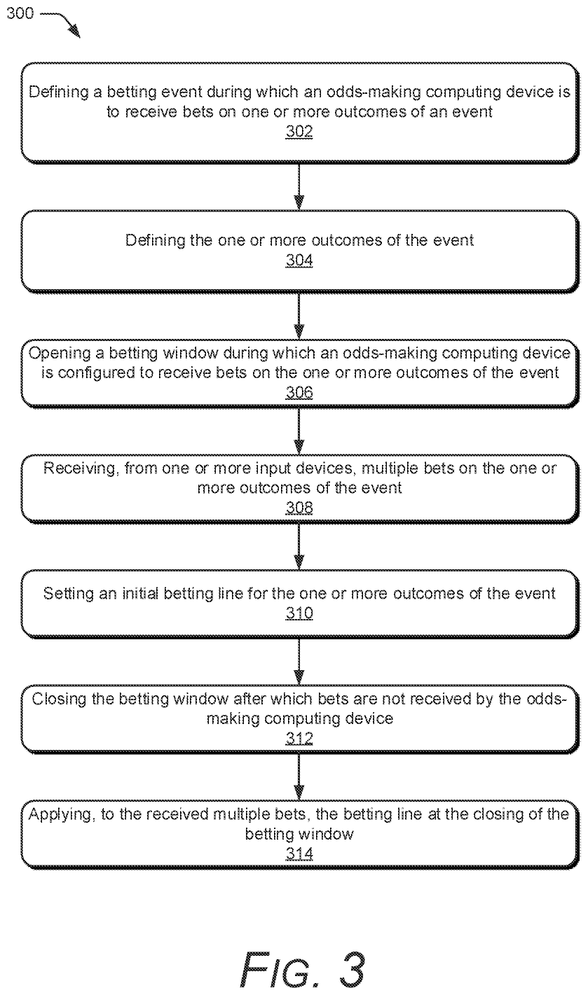

FIG. 3 illustrates a method 300 for managing a betting line, according to an example of the principles described herein. In addition to managing the betting, line, the odds-making computing device 102 may provide a platform in which a user, such as an administrator or a bettor, can create or control a betting event, which is not possible with existing betting systems. In such an example, the odds-making-computing device 102 may control many betting events and set criteria for the betting events. At 302, via user input, the odds-making computing device 102 may define the event for which the odds-making computing device 102 is to receive bets on one or more outcomes of the event. At 304, the one or more outcomes for the event are defined. In other words, the odds-making computing device 102/administrator can determine event and outcome options with betting outcomes set to capture all possible outcomes. The event may be any future event with an unknown outcome. More specifically, in an example, the event may be the outcome of a reality TV show or popular vote in a political race.

In an example, the method 300 includes setting at least one of betting participants and betting limits for the event. For example, the odds-making computing device 102/administrator may limit participants based on geographic location, total number of participants, invited participants only, participants in a specific state or country. As a specific example, a small group of individuals that know each other may use the odds-making computing device 102 to bet on an event without permitting other participants. Still further, the odds-making computing device 102/administrator may control betting limits (minimum or maximum bets) of each participant or limit aggregate amount on the event. In one particular example, the odds-making computing device 102/administrator can sponsor an event by putting money in, not as a bettor but as a sponsor, providing for an increased betting pool for other bettors.

In an example, the odds-making computing device 102/administrator can create series events and or other betting games. That is, the event may include a series of sub-events. As a specific example, the odds-making computing device 102/administrator may create a series of sub-events which can be limited to a genre or predefined or not, with all bettors required to choose an outcome option in a string of sub-events with each losing bettor being removed until only one bettor remains. Further, such a series of betting sub-events could be pre-set at the outset with the group of bettors at the conclusion receiving the betting proceeds proportional to bet amount or each future event could be determined by the platform/bettor after the immediately prior event concludes.

At operation 306, the odds-making computing device 102 opens a betting window during which the odds-making computing device 102 is to receive bets on one or more outcomes of the event. At operation 308, the odds-making computing device 102 receives, from one or more input devices 116, multiple bets on the one or more outcomes of the event. At operation 310, the odds-making computing device 102 sets an initial betting line for the one or more outcomes of the event. At operation 312, the odds-making computing device 102 closes the betting window after which bets are no longer received by the odds-making computing device 102. At operation 314, the odds-making computing device 102 applies, to the received multiple bets, the betting line at the closing of the betting window as a final betting line.

In some examples, the method 300 may include the dynamic adjustment of the initial betting line as described above. For example, in some examples, the odds-making computing device 102 may provide a bet commitment window as described above.

Moreover, in addition to receiving multiple bets on the one or more outcomes of the event, the odds-making computing device 102 may receive, during the betting window, a modification to one or more of the multiple bets. In this example, the odds-making computing device 102 may dynamically adjust an initial betting line based on the received multiple bets and provide, to one or more output devices 126, a current value of the dynamically adjusted betting line. Upon closing of the betting window, the odds-making computing device 102, applies, to the received multiple bets, the dynamically adjusted betting line at the closing of the betting window as a final betting window.

In some examples, the odds-making computing device 102 may be a mobile phone or a personal computer and may be co-located with either an input device 116 and an output device 126.

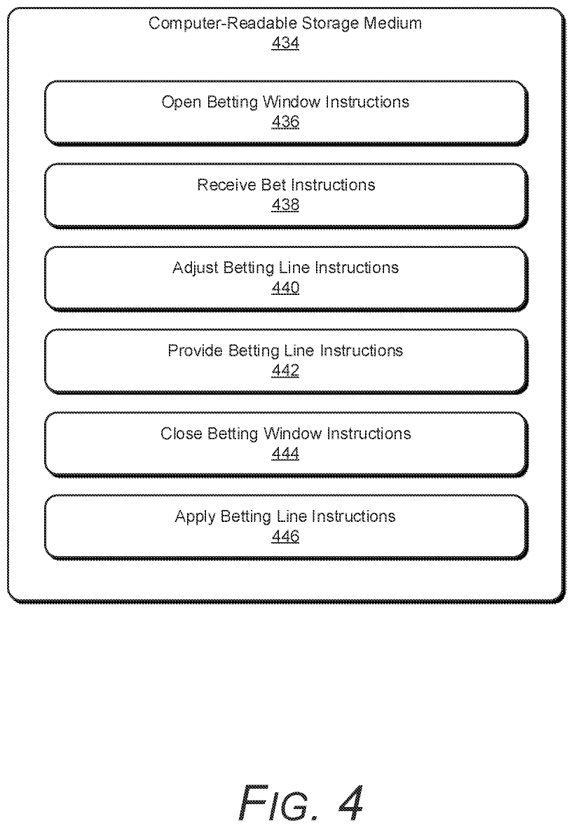

FIG. 4 depicts a non-transitory computer-readable storage medium 434 for managing a dynamic betting line, according to an example of the principles described herein. To achieve its desired functionality, an odds-making computing device 102 includes various hardware components. Specifically, an odds-making computing device 102 includes a processor 104 and a computer-readable storage medium 434. The computer-readable storage medium 434 is communicatively coupled to the processor 104. The computer-readable storage medium 434 includes a number of instructions 436, 438, 440, 442, 444, 446 for performing a designated function. The computer-readable storage medium 434 causes the processor to execute the designated function of the instructions 436, 438, 440, 442, 444, 446. The computer-readable storage medium 434 can store data, programs, instructions, or any other computer-readable data that can be utilized to operate the odds-making computing device 102. Computer-readable storage medium 434 can store computer readable instructions that the processor of the odds-making computing device 102 can process, or execute. The computer-readable storage medium 434 can be an electronic, magnetic, optical, or other physical storage device that contains or stores executable instructions. Computer-readable storage medium 434 may be, for example, Random Access Memory (RAM), an Electrically Erasable Programmable Read-Only Memory (EEPROM), a storage device, an optical disc, etc. The computer-readable storage medium 434 may be a non-transitory computer-readable storage medium 434, where the term “non-transitory” does not encompass transitory propagating signals.

Referring to FIG. 4, open betting window instructions 436, when executed by the processor 104, cause the processor 104 to, open a betting window during which the dynamic odds-making computing device 102 is to receive bets on one or more outcomes of an event. Receive bet instructions 438, when executed by the processor 104, cause the processor 104 to, receive, from one or more input devices 116, multiple bets on the one or more outcomes of the event. Adjust betting line instructions 440, when executed by the processor 104, cause the processor 104 to, dynamically adjust a betting line based on received multiple bets. Provide betting line instructions 442, when executed by the processor 104, cause the processor 104 to, provide, to the one or more output devices 126, a current value of a dynamically adjusted betting line. Close betting window instructions 444, when executed by the processor 104, cause the processor 104 to, close the betting window after which bets are not received by the odds-making computing device 102. Apply betting line instructions 446, when executed by the processor 104, cause the processor 104 to, apply to the received multiple bets, the dynamically adjusted betting line at the closing of the betting window as a final betting line.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A dynamic odds-making computing device comprising:
one or more computer processors;
one or more computer-readable storage media comprising instructions stored thereon that, responsive to execution by the one or more computer processors, cause the dynamic odds-making computing device to perform operations comprising:
opening a betting window during which the dynamic odds-making computing device is to receive bets on one or more outcomes of an event;
receiving, from one or more input devices, multiple bets on the one or more outcomes of the event;
dynamically adjusting a betting line based on received multiple bets;
providing, to the one or more output devices, a current value of a dynamically adjusted betting line;
closing the betting window after which bets are not received by the odds-making computing device; and
applying, to the received multiple bets, the dynamically adjusted betting line at the closing of the betting window as a final betting line.

2. The dynamic odds-making computing device of claim 1, wherein, during the betting window, the operations further comprise receiving a modification to one or more of the multiple bets, the modification including changing the one or more of the multiple bets to an outcome that is different from an initially chosen outcome for the one or more of the multiple bets.

3. The dynamic odds-making computing device of claim 1, wherein the operations further comprise:
providing, to the one or more output devices, sponsored media; and
receiving, from a sponsor of the sponsored media, compensation for providing the sponsored media

4. The dynamic odds-making computing device of claim 1, wherein the operations further comprise:
providing a bet commitment window, wherein the dynamic odds-making computing device receives a commitment of funds to betting on the event; and
closing the bet commitment window, wherein the committed funds are non-refundable and are to be used for a bet on the event.

5. The dynamic odds-making computing device of claim 4, wherein the operation of closing the bet commitment window occurs before the opening of the betting window.

6. The dynamic odds-making computing device of claim 4, wherein the operation of closing the bet commitment window occurs during the betting window.

7. The dynamic odds-making computing device of claim 1, wherein dynamically adjusting the initial betting line for a particular outcome is based on a ratio of a total amount of funds used for bets on other outcomes of the event to a total amount of funds used for bets on the particular outcome of the event.

8. The dynamic odds-making computing device of claim 1, wherein one or more of the input devices and output devices are remote from the dynamic odds-making computing device.

9. A method performed by a dynamic odds-making computing device for betting on an event, the method comprising:
opening a betting window during which the dynamic odds-making computing device is to receive bets on one or more outcomes of the event;
receiving, from one or more input devices, multiple bets on the one or more outcomes of the event;
dynamically adjusting an initial betting line based on received multiple bets;
providing, to one or more output devices, a current value of a dynamically adjusted betting line;
closing the betting window after which bets are not received by the dynamic odds-making computing device; and
applying, to the received multiple bets, the dynamically adjusted betting line at the closing of the betting window as a final betting line.

10. The method of claim 9, wherein, during the betting window, the method further comprises receiving a modification to one or more of the multiple bets, the modification including changing the one or more of the multiple bets to an outcome that is different from an initially chosen outcome for the one or more of the multiple bets.

11. The method of claim 9, further comprising:
providing a bet commitment window, wherein the dynamic odds-making computing device receives a commitment of funds for betting on the event; and
closing the bet commitment window, wherein the committed funds are non-refundable and are to be used for a bet on the event.

12. The method of claim 11, wherein closing the bet commitment window occurs before or concurrently with opening the betting window.

13. The method of claim 11, wherein closing the bet commitment window occurs during a portion of the betting window.

14. The method of claim 9, wherein dynamically adjusting the initial betting line for a particular outcome is based on a ratio of a total amount of funds used for bets on other outcomes of the event to a total amount of funds used for bets on the particular outcome of the event.

15. The method of claim 9, wherein one or more of said input devices and output devices are remote from the dynamic odds-making computing device.

16. The method of claim 9, wherein providing, to one or more output devices, a current value of the dynamically adjusted betting line includes providing the current value of the dynamically adjusted betting line to multiple output devices located in multiple different cities.

17. A method performed by an odds-making computing device for betting on an event, the method comprising:
defining an event for which the odds-making computing device is to receive bets on one or more outcomes of the event;
defining the one or more outcomes of the event;
opening a betting window during which the odds-making computing device is to receive bets on the one or more outcomes of the event;
receiving, from one or more input devices, multiple bets on the one or more outcomes of the event;
setting an initial betting line for the one or more outcomes of the event;
closing the betting window after which bets are not received by the odds-making computing device; and
applying to received multiple bets, the betting line at the closing of the betting window.

18. The method of claim 17, further comprising:
dynamically adjusting the initial betting line based on the received multiple bets;
providing, to one or more output devices, a current value of the dynamically adjusted betting line; and
applying, to the received multiple bets, the dynamically adjusted betting line at the closing of the betting window as a final betting line.

19. The method of claim 17, further comprising setting at least one of betting participants and betting limits for the event.

20. The method of claim 17, wherein:
the event comprises a series of betting sub-events;
a bettor is to choose an outcome for each sub-event; and
a losing bettor is removed until one bettor remains.
